(19) United States
(12) Patent Application Publication
(10) Pub. No.: US 2016/0312764 A1
(43) Pub. Date: Oct. 27, 2016

(54) TURBINE BLADE APPARATUS

(71) Applicant: Kuo-Chang Huang, Tainan City (TW)

(72) Inventor: Kuo-Chang Huang, Tainan City (TW)

(21) Appl. No.: 15/132,421

(22) Filed: Apr. 19, 2016

(30) Foreign Application Priority Data
Apr. 22, 2015 (TW) 104112887

(51) Int. Cl. F03D 3/00; F03D 3/06

(52) U.S. Cl. CPC F03D 3/005; F03D 3/065

(57) ABSTRACT

A turbine blade apparatus is adapted to be pushed by a fluid to rotate. The turbine blade apparatus includes a rotary shaft and at least one blade assembly. The rotary shaft extends along an axis, and is rotatable in a rotation direction about the axis. The blade assembly is co-rotatably connected to the rotary shaft, helically extends around the rotary shaft, and includes a plurality of blade units that are helically arranged around the rotary shaft. Each of the blade units includes a grid frame co-rotatably connected to the rotary shaft, and a plurality of blade panels connected to the grid frame. The blade panels of one of the blade units face in a direction different from that of the blade panels of another one of the blade units.

### CROSS-REFERENCE TO RELATED APPLICATION

This application claims priority of Taiwanese Patent Application No. 104112887, filed on Apr. 22, 2015.

### FIELD

The disclosure relates to a turbine blade apparatus, and more particular to a turbine blade apparatus is capable of being efficiently operated in an environment of low fluid speed or varying fluid direction.

### BACKGROUND

A wind power generator is an apparatus that includes a rotational member, and that utilizes the natural wind to push the rotational member to rotate and generates electric power. Comparing to generators that utilize fossil fuels or coals for electric power generation, the wind power generator is more economical friendly and produces less pollution. Therefore, nations worldwide increase spending in research of wind power generators. One of the factors that influence the efficiency of the wind power generator in power generation resides in the design of blade panels of the wind power generator. The shape, number, position, orientation, etc. will all influence rotation of the blade panels.

A conventional wind power generator includes a rotary shaft, and a plurality of rectangular-shaped blade panels that are connected to the rotary shaft and that are angularly spaced apart from each other relative to the rotary shaft. A wind blown toward the conventional wind power pushes the blade panels and therefore drives the rotary shaft to rotate. Each of the blade panels faces in a particular direction. The wind may not be blown perpendicularly onto any of the blade panels, and the wind may not be efficiently utilized. As a result, the conventional wind power generator has a larger cut-in wind speed, which is defined as the wind speed where the conventional wind power generator starts to generate power. In other words, the conventional wind power generator may not be able to operate efficiently in an environment that has low wind speed or varying wind direction.

### SUMMARY

Therefore, an object of the present disclosure is to provide a turbine blade apparatus that can alleviate at least one of the drawbacks associated with the prior art.

According to the present disclosure, a turbine blade apparatus is adapted to be pushed by a fluid to rotate. The turbine blade apparatus includes a rotary shaft and at least one blade assembly.

The rotary shaft extends along an axis, and is rotatable in a rotation direction about the axis.

The at least one blade assembly is co-rotatably connected to the rotary shaft, helically extends around the rotary shaft, and includes a plurality of blade units that are helically arranged around the rotary shaft. Each of the blade units includes a grid frame that is co-rotatably connected to the rotary shaft, and a plurality of blade panels that are connected to the grid frame.

The blade panels of one of the blade units faces in a direction different from that of the blade panels of another one of the blade units.

### BRIEF DESCRIPTION OF THE DRAWINGS

Other features and advantages of the present disclosure will become apparent in the following detailed description of the embodiments with reference to the accompanying drawing, of which:

FIG. 1 is a perspective view showing a first embodiment of the turbine blade apparatus according to the present disclosure;

FIG. 2 is a schematic top view of the first embodiment;

FIG. 3 is a perspective view of a second embodiment of the turbine blade apparatus according to the present disclosure; and

FIG. 4 is a fragmentary schematic view of a third embodiment of turbine blade apparatus according to the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

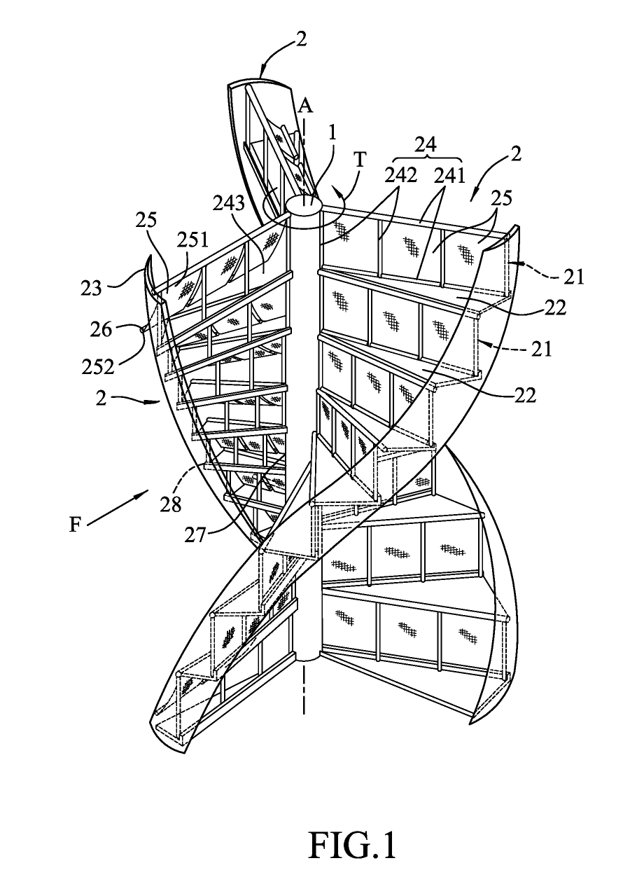

Referring to FIG. 1, the first embodiment of the turbine blade apparatus is adapted to be pushed by a fluid that flows in a flow direction (F). The turbine blade apparatus includes a rotary shaft 1 and at least one blade assembly 2. The fluid may be wind or water, depending on the application of the turbine blade apparatus.

The rotary shaft 1 extends along an axis (A), and is rotatable in a rotation direction (T) about the axis (A). In this embodiment, the rotary shaft 1 extends vertically, and may be mounted on a stage (not shown). As a result, in this embodiment, the turbine blade apparatus is a vertical turbine blade apparatus.

It should be pointed out that the number of the blade assembly 2 may be one of more than one, according to practical requirements. In this embodiment, the turbine blade apparatus includes three blade assemblies 2. Each of the blade assemblies 2 is co-rotatably connected to the rotary shaft 1, helically extends around the rotary shaft 1, and extend angularly 120 degrees relative to the axis (A). The blade assemblies 2 are angularly spaced apart from each other relative to the axis (A), by 120 degrees. In one alternative embodiment, the turbine blade apparatus may include only one blade assembly 2 that extends angularly more than 360 degrees relative to the axis (A).

In this embodiment, since the structures of the blade assemblies 2 are identical to each other, only one of the blade assemblies 2 will be described in detail hereinafter for the sake of brevity.

The blade assembly 2 includes a plurality of blade units 21, a plurality of connecting walls 22 and a fluid-guiding plate 23.

Each of the blade units 21 includes a grid frame 24 that is co-rotatably connected to the rotary shaft 1, a plurality of blade panels 25 that are connected to the grid frame 24, and a plurality of counterweight members 26. The blade units 21 are helically arranged around the rotary shaft 1 such that one of the blade units 21 faces in a direction different from that of another one of the blade units 21. In other words, the blade panels 25 of each of the blade units 21 face in a direction different from that of the blade panels 25 of any of the remaining blade units 21.

In each of the blade units 21, the grid frame 24 includes a plurality of first grid rods 241 and a plurality of second grid rods 242. Each of the first grid rods 241 extends in a radial direction with respect to the axis (A). The first grid rods 241 are spaced apart from each other in an axial direction with respect to the axis (A). Each of the second grid rods 242 extends in the axial direction. The second grid rods 242 are spaced apart from each other in the radial direction. The first grid rods 241 and the second grid rods 242 cooperatively define a plurality of grid spaces 243 for the blade panels 25 to be respectively disposed therein. Each of the blade panels 25 has a connecting end 251 that is pivotally connected to the upper first grid rod 241 of the grid frame 24, and a swinging end 252 that is opposite to the connecting end 251 and that is swingable between a covering position to cover a corresponding one of the grid spaces 243, where the swinging end 252 abuts against the lower first grid rod 241 of the grid frame 24, and an opening position to uncover the corresponding one of the grid spaces 243, where the swinging end 252 is spaced apart from the lower first grid rod 241. Each of the counterweight members 26 is disposed on the swinging end 252 of a respective one of the blade panels 25. Each of the counterweight members 26 provides a force to maintain the swinging end 252 of a corresponding one of the blade panels 25 to abut against the corresponding lower first grid rod 241 when the corresponding one of the blade panels 25 is not pushed by the fluid. The connecting mechanism between each of the blade panels 25 and a corresponding one of the upper first grid rod 241 of the grid frame 24 may be locking screw, hinge, etc., and may be changed according to practical requirements. At least a part of the swinging end 252 of each of the blade panels 25 may be folded upwardly to define a space for receiving a corresponding one of the counterweight members 26.

Each of the connecting walls 22 interconnects two adjacent ones of the blade units 21. In this embodiment, each of the connecting walls 22 is triangular shaped, so that the blade assembly 2 is shaped as helical stairs. It should be noted that the shape of each of the connecting walls 22 may be rectangular shaped, circular sector shaped, etc., and may be changed according to practical requirements.

In this embodiment, the blade assembly 2 includes eight blade units 21. Since the blade assembly 2 extends 120 degrees with respect to the axis (A), an included angle between a normal direction of the blade panels 25 of one of the blade units 21 and another normal direction of the blade panels 25 of an adjacent one of the blade units 21 can be calculated as 120°/7≈17.1°. The angle of each of the triangular shaped connecting walls 22 that is defined between the lower first grid rod 241 of a corresponding one of the grid frames 24 and the upper first grid rod 241 of an adjacent one of the grid frames 24 is also around 17.1 as calculated above.

In one embodiment, the blade assembly 2 has an inner end 27 that is co-rotatably connected the rotary shaft 1, and an outer end 28 that is opposite to the inner end and that is distal from the rotary shaft 1. The fluid-guiding plate 23 is connected to the outer end 28, extends in a direction opposite to the rotation direction (T), and has a substantial arc shape centered at the axis (A) for confining a part of the fluid flowing onto the blade assembly 2.

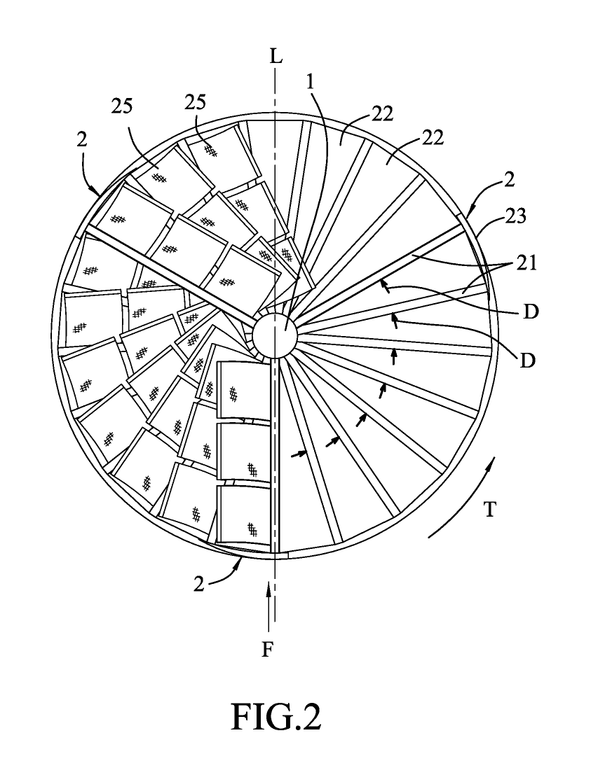

FIG. 2 is a schematic top view of the first embodiment of the turbine blade apparatus. When viewing from the top, the turbine blade apparatus may be divided into a right part and a left part by a line (L). The fluid flows toward the turbine blade apparatus in the flow direction (F). In the right part of the turbine blade apparatus, the swinging end 252 of each of the blade panels 25 of each of the blade units 21 is pushed by the fluid to the covering position, such that the entire turbine blade apparatus is pushed by the fluid. A plurality of pushing directions (D) are shown in FIG. 2 to indicate the pushing force exerted by the fluid on the right part of the turbine blade apparatus. Meanwhile, in the left part of the turbine blade apparatus, the swinging end 252 of each of the blade panels 25 of each of the blade units 21 is pushed by the fluid to the opening position, so as to avoid generating an unfavorable resistance force that would push the turbine blade apparatus in the direction opposite to the rotation direction (T).

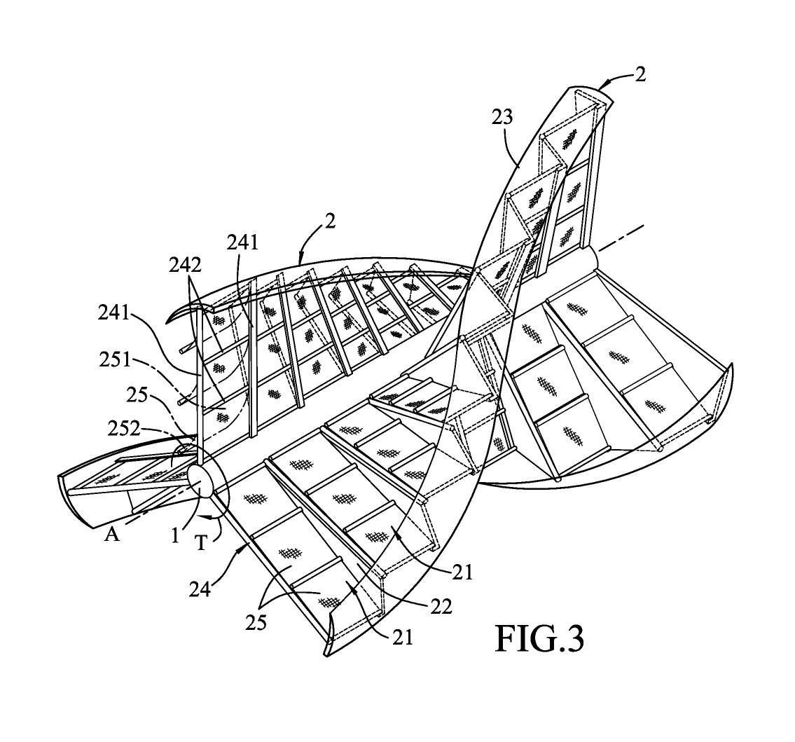

Referring to FIG. 3, a second embodiment of the turbine blade apparatus has a structure similar to that of the first embodiment, with differences described hereinafter.

In the second embodiment, the turbine blade apparatus is a horizontal turbine blade apparatus (i.e., rotary shaft 1 extends horizontally). In one embodiment, a rack (not shown) may be used to support opposite ends of the rotary shaft 1. In another embodiment, the opposite ends of the rotary shaft 1 may be respectively connected to two adjacent buildings (not shown). In yet another embodiment, the horizontal turbine blade apparatus may be connected to a rotatable object (not shown), and a fluid-guiding member (not shown) may be provided to the horizontal turbine blade apparatus for improving efficiency of the same.

In each of the blade units 21 of each of the blade assemblies 2, the connecting end 251 of each of the blade panels 25 is pivotally connected to a corresponding one of the second grid rods 242.

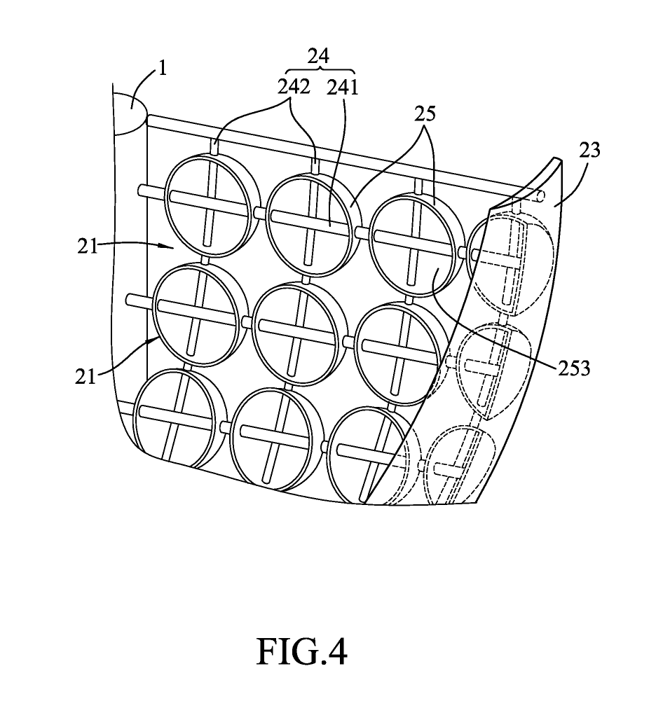

Referring to FIG. 4, a third embodiment of the turbine blade apparatus has a structure similar to that of the first embodiment, with differences described hereinafter.

In the third embodiment, each of the blade panels 25 of each of the blade units 21 is bowl shaped, and has a concave surface 253 facing the fluid flowing thereto so as to be pushed by the fluid. In each of the blade units 21 of each of the blade assemblies 2, the grid frame 24 includes one first grid rod 241 and a plurality of second grid rods 242. The first grid rod 241 extends in a radial direction with respect to the axis (A). Each of the second grid rods 242 extends in an axial direction with respect to the axis (A). The second grid rods 242 are spaced apart from each other in the radial direction. Each of the blade panels 25 is disposed fixedly on the first grid rod 241 and a corresponding one of the second grid rods 242. The fixing mechanism among each of the blade panels 25, the first grid rod 241 and the corresponding one of the second grid rods 242 may be interference fitting, screw fixing, rope fixing, etc., and may be changed according to practical requirements. It should be noted that the third embodiment of the turbine blade apparatus may also be configured as a horizontal apparatus as the second embodiment.

With the configuration of the blade assemblies 2, the turbine blade apparatus is capable of utilizing the fluid more efficiently and minimizing the unfavorable force that is generated by the fluid in the direction opposite to the rotation direction (T). Therefore, the turbine blade apparatus of this disclosure is capable of being efficiently operated in an environment of low fluid speed or varying fluid direction.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment (s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A turbine blade apparatus adapted to be pushed by a fluid to rotate, said turbine blade apparatus comprising:
a rotary shaft that extends along an axis, and that is rotatable in a rotation direction about the axis; and
at least one blade assembly co-rotatably connected to said rotary shaft, helically extending around said rotary shaft, and including a plurality of blade units that are helically arranged around said rotary shaft, each of said blade units including a grid frame co-rotatably connected to said rotary shaft and a plurality of blade panels connected to said grid frame,
wherein said blade panels of one of said blade units face in a direction different from that of said blade panels of another one of said blade units.

2. The turbine blade apparatus as claimed in claim 1, wherein said grid frame of each of said blade units defines a plurality of grid spaces for said blade panels to be respectively disposed therein, each of said blade panels of each of said blade units having a connecting end that is pivotally connected to said grid frame, and a swinging end that is opposite to said connecting end and that is swingable between a covering position to cover a corresponding one of said grid spaces of said grid frame, where said swinging end abuts against said grid frame, and an opening position to uncover the corresponding one of said grid spaces of said grid frame, where said swinging end is spaced apart from said grid frame.

3. The turbine blade apparatus as claimed in claim 2, wherein, in each of said blade units, said grid frame includes a plurality of first grid rods, each of which extends in a radial direction with respect to the axis and which are spaced apart from each other in an axial direction with respect to the axis, and a plurality of second grid rods, each of which extends in the axial direction and which are spaced apart from each other in the radial direction, said first grid rods and said second grid rods cooperatively defining said grid spaces.

4. The turbine blade apparatus as claimed in claim 1, wherein said blade assembly further includes a plurality of connecting walls, each of which interconnects two adjacent ones of said blade units.

5. The turbine blade apparatus as claimed in claim 2, wherein each of said blade units further includes a plurality of counterweight members, each of which is disposed on said swinging end of a respective one of said blade panels.

6. The turbine blade apparatus as claimed in claim 1, wherein each of said blade panels of each of said blade units has a concave surface facing the fluid flowing thereto so as to be pushed by the fluid.

7. The turbine blade apparatus as claimed in claim 6, wherein said grid frame includes a first grid rod that extends in a radial direction with respect to the axis, and a plurality of second grid rods, each of which extends in an axial direction with respect to the axis and which are spaced apart from each other in the radial direction, each of said blade panels being disposed fixedly on said first grid rod and a corresponding one of said second grid rods.

8. The turbine blade apparatus as claimed in claim 1, wherein said blade assembly has an inner end that is co-rotatably connected to said rotary shaft, and an outer end that is opposite to said inner end and that is distal from said rotary shaft, and further includes a fluid-guiding plate that is connected to said outer end and that extends in a direction opposite to the rotation direction.

9. The turbine blade apparatus as claimed in claim 1, wherein said turbine blade apparatus comprises a plurality of said blade assemblies that are angularly spaced apart from each other relative to the axis.
